(19) United States
(12) Patent Application Publication
(10) Pub. No.: US 2016/0253455 A1
(43) Pub. Date: Sep. 1, 2016

(54) MEDICAL IMAGE DISPLAY APPARATUS

(71) Applicant: NATIONAL INSTITUTE OF RADIOLOGICAL SCIENCES, Chiba (JP)

(72) Inventors: Shin HASEGAWA, Chiba-shi, Chiba (JP); Yasuo OKUDA, Chiba-shi, Chiba (JP)

(73) Assignee: National Institute of Radiological Sciences, Chiba (JP)

(21) Appl. No.: 15/027,160

(22) PCT Filed: Jan. 29, 2014
(86) PCT No.: PCT/JP2014/000456

§ 371 Date: Apr. 4, 2016

(30) Foreign Application Priority Data
Oct. 4, 2013 (JP) 2013-209143

(51) Int. Cl. G06F 19/00; G06F 3/0484; G09G 5/06; H04B 3/54; G06T 11/00

(52) U.S. Cl. CPC G06F 19/321; H04B 3/54; G06T 11/001; G09G 5/06; G06F 3/04845; G06F 3/04847; G09G 2380/08; G09G 2354/00; G09G 2320/0271; G06T 2210/41

(57) ABSTRACT

A viewer part 38b accesses an image viewer web server 14 by a user terminal 16, in which a medical image display program 38 is installed, to acquire at least medical image data 13a, input data accepted in a touch input part 21a is transmitted in an input transmission part 31 and is transferred to the image viewer web server 14, the medical image data 13a outputted from the image viewer web server 14 is acquired in a capture acquisition part 34, at least a medical image data 13a portion is subjected to image conversion in an image conversion part 35, and image data for display after conversion is outputted to a display part 23 by an output part 36. Accordingly, there is provided a medical image display device that can display a medical image in proper gradation without using color management by hardware, and without performing modification corresponding to gradation correction to an individual application having a display function of the medical image.

### TECHNICAL FIELD

The present invention relates to a medical image display program, a medical image display method, a medical image display device, and a medical image display system which correct gradation of a medical image to perform display with display quality in the gradation.

### BACKGROUND ART

Conventionally, a terminal that displays a medical image is calibrated to GSDF (Grayscale Standard Display Function) provided in DICOM 3.0 Part 14 of the DICOM (Digital Imaging and Communications in Medicine) standard. In the case of a desktop type terminal for image reference, the calibration is performed by acquiring display gradation characteristic data of a monitor, using a luminance meter or the like and changing an LUT (Lookup Table) of the monitor in accordance with this display gradation characteristic data. This keeps quality of the medical image displayed in the terminal.

At a medical site, it is desired to share the medical image through a network system. As a method for sharing the medical image through the network system, various methods have been proposed.

For example, there has been proposed a medical network system in which an image processing server mounted with an image processing component is provided to enable a processed image to be displayed in a reference terminal (refer to Patent Document 1). In this medical network system, the reference terminal transfers image data and an image parameter to the image processing server, the image processing server performs image processing, and the reference terminal displays the processed image. This enables the image to be referred to, using only a communication function standardly mounted on a personal computer, so that the general-purpose personal computer can be used as the reference terminal in the medical network system as it is.

Moreover, there have been proposed a medical image network system and an image display method that ensure consistency in a way in which an output image is viewed (refer to Patent Document 2). In this system, a reference terminal sends display gradation characteristic data and image data of the reference terminal to an image processing device, the image processing device applies image processing such as gradation correction processing, and the image processing device sends processed image data to the reference terminal through an image server. This enables the medical image network system to display the image data in gradation that allows an image reading doctor who refers to the image to easily view the image, so that the image that facilitates diagnosis in consideration of an individual difference of the image reading doctor can be provided.

There have also been proposed an image management system and an image management method, and an image display device that compensate for changes in gradation characteristics due to aging of hardware (refer to Patent Document 3). In this system, a gradation table prescribing the gradation characteristics on a basis of a display is held in an image file server, and the optimal gradation table is automatically selected in accordance with changes in maximum luminance due to aging, so that an image can be outputted and displayed, using a gradation correction curve close to an ideal.

However, these systems have a problem that a server to hold and manage the display gradation characteristic data of the reference terminal is required, which requires tremendous costs for introduction. Therefore, there has been desired a mechanism for managing image quality and displaying an image in an optimal gradation without adding a new function to an already-introduced configuration as much as possible.

In recent years, various portable terminals such as a tablet terminal represented by an iPad (registered trademark), a smartphone, and the like have been provided. Shift to cloud computing of a medical image management device, and spread of a portable terminal at a medical site have been advanced. Thus, it is desired that a medical image is referred to in the above-described portable terminal as well.

However, the above-described portable terminal is not calibrated to GSDF, and in many cases, has no function of changing an LUT of a monitor, or is prohibited from changing the LUT. Therefore, the methods of Patent Documents 1 to 3 cannot cope with the above demands, and it has been difficult to manage the display quality of the medical image.

Here, a method of performing gradation correction by software can be considered as coping with a case where a function of performing color management is not prepared in hardware.

However, when the gradation correction is performed by software, modification for corresponding to gradation correction is required on a basis of application that displays the medical image, which poses a problem of increasing costs.

### PRIOR ART DOCUMENTS

### Patent Documents

Patent Document 1: Japanese Patent Laid-open Publication No. H11-239165

Patent Document 2: Japanese Patent Laid-open Publication No. 2005-131241

Patent Document 3: Japanese Patent Laid-open Publication No. 2002-306425

### SUMMARY OF THE INVENTION

### Problems to be Solved by the Invention

The present invention is achieved in light of the above-described problems, and an object of the present invention is to provide a medical image display program, a medical image display method, a medical image display device, and a medical image display system which enable a medical image to be displayed in proper gradation without using color management by hardware, and without performing modification corresponding to gradation correction to an individual application having a display function of the medical image.

### Solutions to the Problems

A medical image display program according to the present invention causes a computer to function as a communication application part that accesses, through an electric communication line, a computer that acquires medical image data to acquire at least the medical image data, an input acceptance part that accepts manipulation input by a user, an input data transfer part that transfers input data accepted in the input acceptance part to the communication application part, a display image data acquisition part that acquires image data for display including the medical image data outputted from the communication application part, an image conversion part that performs image conversion of at least a medical image data portion of the image data for display, and a display output part that outputs the image data for display after conversion to a display part.

### Effects of the Invention

According to the present invention, it is possible to provide a medical image display program, a medical image display method, a medical image display device, and a medical image display system which enable a medical image to be displayed in proper gradation without using color management by hardware and without performing modification corresponding to gradation correction to an individual application having a display function of the medical image.

### BRIEF DESCRIPTION OF THE DRAWINGS

FIGS. 1(A) and 1(B) are block diagrams illustrating a configuration of a medical image display system of a first embodiment.

FIGS. 2(A) to 2(D) are a flowchart and explanatory diagrams of a screen of a user terminal of the first embodiment.

FIGS. 3(A) and 3(B) are block diagrams illustrating a configuration of a medical image display system of a second embodiment.

FIGS. 4(A) and 4(B) are block diagrams illustrating a configuration of a medical image display system of a third embodiment.

FIGS. 5(A) to 5(D) are explanatory diagrams of a configuration and a screen of a medical image display system of a fourth embodiment.

### EMBODIMENTS OF THE INVENTION

Hereinafter, embodiments of the present invention will be described with reference to the drawings.

### First Embodiment

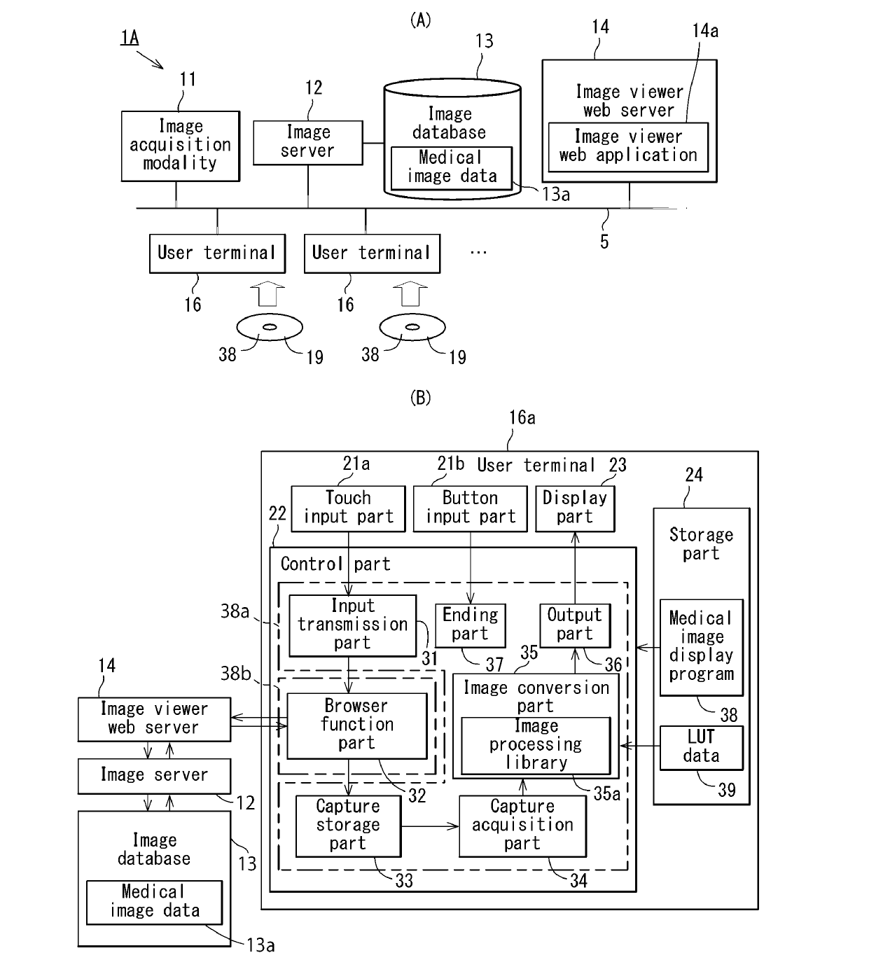

FIG. 1(A) is a block diagram illustrating a system configuration of a medical image display system 1A of a first embodiment. The medical image display system 1A has an image acquisition modality 11, an image server 12, an image viewer web server 14 (an external computer), a user terminal 16 (a computer) as a medical image display device, which are connected to an electric communication line 5 such as the Internet. In the user terminal 16, a medical image display program 38 stored in a storage medium 19 is installed. The medical image display program 38 may be installed by downloading the same from a web server on the Internet.

A configuration may be such that two or all functions (a server function, a computer function) of a computer section of the image acquisition modality 11, the image server 12, and the image viewer web server 14 are loaded on one server.

Hereinafter, while embodiments will be described with an example in which an iPad (registered trademark), which is one type of tablet terminal, is used as the user terminal 16, the present invention is not limited thereto, and various terminals such as an ANDROID (registered trademark) terminal, a tablet PC, a notebook personal computer, and a desktop personal computer can be used.

The image acquisition modality 11 is a device to acquire, as digital data, a medical image obtained by photographing a human body, such as CT (Computed Tomography), MRI (Magnetic Resonance Imaging), CR (Computed Radiography), an FPD (Flat Panel Detector), an ultrasonic diagnostic device, PET (Positron Emission Tomography), and SPECT (Single Photon Emission Computed Tomography). The image acquisition modality 11 has a signal acquisition part that acquires a signal in accordance with a type of a method, a medical image data creation part that creates medical image data from the acquired signal, and a data sending part that sends the created medical image data to the image server 12.

The image server 12 receives the medical image data from the image acquisition modality 11 and stores the same in an image database 13. The image server 12 has a storage part that stores data of the image database 13 and the like and a program, an input part such as a mouse, a keyboard, or a touch panel that accepts manipulation input, a display part that performs display, a communication part that communicates through the electric communication line 5, and a control part that controls these components.

The image database 13 stores a plurality of pieces of medical image data 13a. Incidental data in accordance with the DICOM standard is attached to this medical image data 13a. The incidental data includes patient data such as a patient name and a patient ID, photographing-related data such as a photographing date, a photographing ID, a photographing region, a photographing condition (a posture, a photographing direction, and the like), and a photographing device, and image-related data such as a pixel number, the number of bits, a designated output size, a reading pixel size, and a maximum density (Dmax) of the medical image.

The image viewer web server 14 functions as a web server, and loads an image viewer web application 14a (an external application) expressed in an HTML or the like. The image viewer web server 14 performs operation by the image viewer web application 14a in accordance with a request of data for manipulation received from a web browser of the user terminal 16, and sends the medical image data 13a stored in the image database 13 of the image server 12 in a form of an image file or the like together with text data expressed by a language such as the HTML (Hyper Text Markup Language) as output data so that the medical image data 13a can be browsed. The image file can be in a form of, for example, a substitute JPEG (Joint Photographic Experts Group). The image viewer web server 14 has a storage part that stores data and a program, an input part such as a mouse, a keyboard, or a touch panel that accepts manipulation input, a display part that performs display, a communication part that communicates through the electric communication line 5, and a control part that controls these components.

The user terminal 16 accesses the image viewer web server 14 to acquire the medical image data 13a, and subjects this medical image data 13a to image conversion and displays the resultant. The user terminal 16 has a storage part that stores data and a program, and an input part such as a mouse, keyboard or a touch panel that accepts manipulation input, a display part that performs display, a communication part that communicates through the electric communication line 5, and a control part that controls these components.

FIG. 1(B) is a block diagram illustrating a hardware configuration and functional blocks of a user terminal 16a when the medical image is displayed by a web-based viewer application, as one example of the user terminal 16.

The user terminal 16a includes a touch input part 21a by a touch panel (an input acceptance part), a button input part 21b by a pressing button used as a home button, a control part 22 configured by a CPU, a ROM, and a RAM, a display part 23 by a high-definition liquid crystal display, and a storage part 24 by a flash memory. The touch input part 21a and the button input part 21b are input devices, and the display part 23 is a display device.

The control part 22 executes a medical image display program 38 stored as an application in the storage part 24 to function as an input/output processing part 38a and a viewer part 38b (a communication application part).

The input/output processing part 38a has an input transmission part 31 as an input data transfer part, a capture storage part 33 as a temporary storage part, a capture acquisition part 34 as a display image data acquisition part, an image conversion part 35, an output part 36, and an ending part 37. This input/output processing part 38a performs control of input and output by the touch input part 21a and the display part 23, which are hardware, delivery of data to the viewer part 38b, image conversion, and end processing by input of the button input part 21b.

The input transmission part 31 delivers an input signal inputted from the touch input part 21a to a browser function part 32 of the viewer part 38b. This input signal is an input signal by touch coordinates, touch start, touch movement, touch end, or the like. This input signal is delivered to the browser function part 32 as it is, by which the browser function part 32 can operate similarly to a single operation of the browser function part 32 where the input/output processing part 38a does not exist.

Moreover, in this manner, the input transmission part 31 transmits the input signal (an input event such as a touch event), which can prevent the medical image display program 38 from performing operation in accordance with the input operation in the touch input part 21a. Particularly, for example, when manipulation of enlarged display by separating two fingers on a touch panel, or reduced display by moving two fingers close to each other is performed, a screen of the medical image display program 38 (a transparent screen by the medical image display program 38) is neither displayed in an enlarged manner nor in a reduced manner, but an image displayed in the viewer part 38b is displayed in an enlarged manner or in a reduced manner. That is, operation is performed in which an image portion displayed by the viewer part 38b is displayed in an enlarged manner or in a reduced manner behind the transparent screen by the medical image display program 38, and a menu portion displayed by the viewer part 38b is neither displayed in an enlarged manner nor in a reduced manner. Thereby, input manipulation of the viewer part 38b can be performed so that a situation is prevented that enlargement/reduction is performed without changing a display range and a resolution of the image displayed in the viewer part 38b, and that the image itself displayed in the viewer part 38b is enlarged/reduced.

The capture storage part 33 is configured, for example, by a RAM to temporarily store a captured image outputted from the browser function part 32. Thereby, image data for display outputted from the browser function part 32 is not directly displayed in the display part 23, but processing such as the image conversion by the input/output processing part 38a can be performed to display the resultant in the display part 23.

The capture acquisition part 34 acquires the image data for display temporarily stored in the capture storage part 33. This allows the image data for display to be subjected to the processing such as the image conversion in the image conversion part 35.

The image conversion part 35 performs the image conversion to at least the medical image data 13a of the image data for display acquired from the capture acquisition part 34. At this time, the image conversion part 35 utilizes an image processing library 35a loaded on the user terminal 16a. For this image processing library 35a, for example, vImage of Accelerate. framework of iOS SDK is used. This can realize processing at a higher speed than that in processing of image conversion in the control part 22 as it is.

The output part 36 outputs, to the display part 23, image data for display after the image conversion outputted from the image conversion part 35. The output part 36 performs this output by passing the designated image (an image captured every frame) to UIImage View, which is an image display component that manages the image display on the screen. This allows the display part 23 to display the image data for display after the image conversion. This enables a user to check the image in proper gradation.

Upon receiving end input in the button input part 21b, the ending part 37 performs end processing. At this time, the control part 22 desirably performs the end processing properly, for example, the control part 22 returns to the home screen in a state where the medical image display program 38 under execution remains activated and expanded on the memory behind, the control part 22 completely ends and erases the medical image display program 38 from the memory to return to the home screen, or the like. This enables the user to activate another application in the user terminal 16a after the end of the medical image display program 38 and use the user terminal 16a for another purpose.

The viewer part 38b has the browser function part 32. The viewer part 38b receives the manipulation input through the input/output processing part 38a, and accesses the image viewer web server 14 and acquires the medical image data 13a to perform capture output to the capture storage part 33.

The browser function part 32 accepts an input signal by image reference manipulation received from the input transmission part 31 in an input signal acceptance part whose illustration is omitted, and accesses the image viewer web server 14 in accordance with this input signal to send data for manipulation, which is manipulation to find the medical image data 13a. The browser function part 32 receives the medical image data 13a as output data of the image server 12 by a function provided by the image viewer web server 14, the medical image data 13a being managed in the image database 13 by the image server 12. At this time, the medical image data 13a is sent to the browser function part 32 together with text data expressed by a language such as the HTML. The browser function part 32 creates the image data for display such as RGB image data for displaying on the screen from the text data including the received medical image data 13a, and performs capture output of this image data for display to the capture storage part 33 by an output part for display whose illustration is omitted.

The storage part 24 stores various programs and data such as the installed medical image display program 38 and LUT data 39.

The LUT data 39 is a lookup table for GSDF conversion which is created beforehand for the user terminal 16a. This lookup table for GSDF conversion can be created by measuring display gradation characteristic information of the user terminal 16a with a proper calibration tool (e.g., Medical QA web Mobile by BALCO or the like).

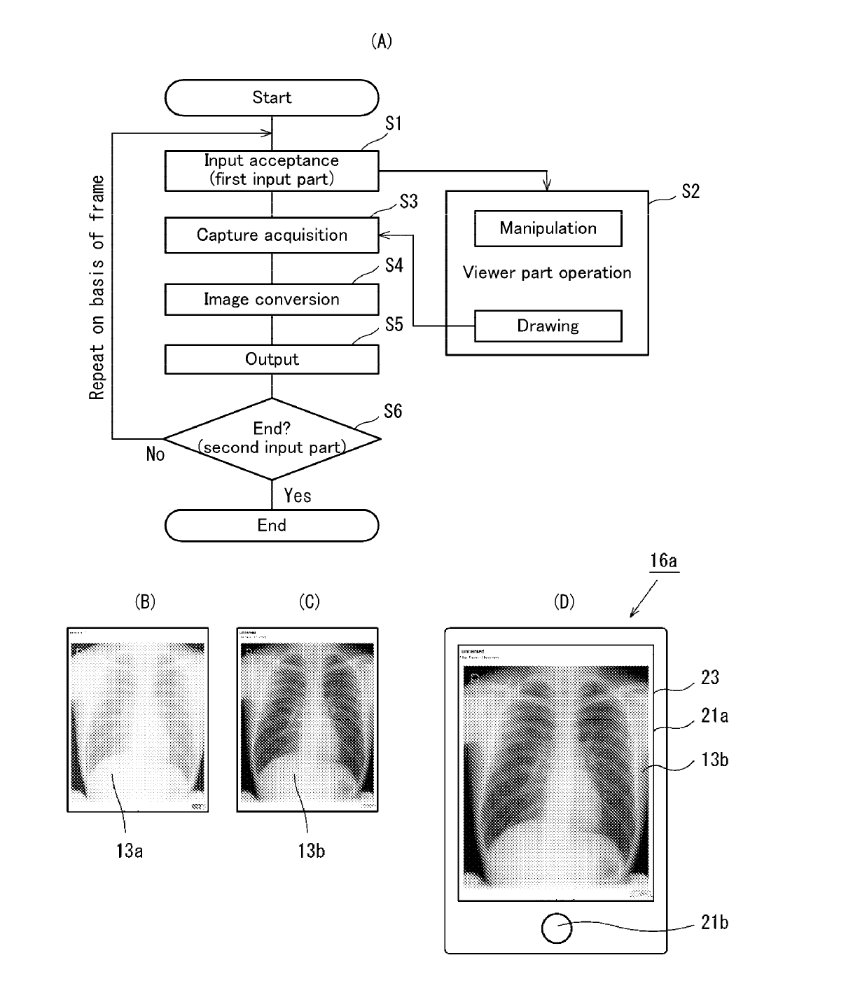

FIG. 2(A) is a flowchart of operation performed by the control part 22 of the user terminal 16 in accordance with the medical image display program 38. Here, an example of the user terminal 16a will be described.

When manipulation of the user activates and starts the medical image display program 38 shown in FIG. 1(B), the control part 22 accepts the input manipulation in touch input part 21a (step S1). At this time, the input/output processing part 38a functions, and the input/output processing part 38a transmits the input data (first input data) inputted in the touch input part 21a by the input transmission part 31, to transfer the same to the viewer part 38b.

When the input data is transmitted by the input transmission part 31 and is transferred to the viewer part 38b, the viewer part 38b performs the operation (step S2). In this embodiment, the browser function part 32 operates as the viewer part 38b, the image reference manipulation by the image viewer web application 14a of the image viewer web server 14 is performed, the medical image data 13a of the image database 13 and the text data are received through the image server 12, and the image data for display is created and drawn from this text data and the medical image data 13a. This drawing is performed so that the image is captured in the capture storage part 33 (the memory) although a general browser draws the image onto a screen of a display device.

The control part 22 acquires the image data for display captured by the capture acquisition part 34 (step S3).

The control part 22 performs the image conversion of the image data for display by the image conversion part 35 (step S4), and the image data after the image conversion is outputted to the display part 23 by the output part 36 (step S5).

The control part 22 repeats steps S1 to S6 in each frame until the end input by the button input part 21b (step S6: No), and if the end input (second input data) is performed by the button input part 21b (step S6: Yes), the control part 22 ends the medical image display program 38 to return the screen to the home screen of an OS (or to a desktop screen).

By the above-described configuration and operation, the user terminal 16a that activates the medical image display program 38 can display the medical image data 13a as medical image data after conversion 13b, which is converted to proper gradation as shown in an image explanatory diagram of FIG. 2(C). If the image conversion were not performed on the medical image data 13a, the gradation would be displayed improperly, as shown in an image explanatory diagram of FIG. 2(B). As shown in an external appearance front diagram of FIG. 2(D), by activating the medical image display program 38 in the user terminal 16a to manipulate the web browser by the touch input in the touch input part 21a, the user can check, in the display part 23, the medical image data after conversion 13b with the gradation converted to the proper gradation. At the end, the user can manipulate the button input part 21b different from the touch input part 21a to end the processing.

Since the medical image display program 38 exerts the same function as a general web browser, it can be operated without modifying a web-based viewer application provided in the image viewer web server 14. In the medical image display program 38, the medical image data 13a is converted to the medical image data after conversion 13b, which is corrected to the GSDF gradation, and the medical image data can be checked in unified gradation with good accuracy by any viewer application. That is, by using the medical image display program 38, a plurality of types of applications that operate on a basis of HTML on the image viewer web server 14 can be arbitrarily operated in the user terminal 16a, and for the medical image data 13a provided regardless of the applications, the medical image data after conversion 13b, which is corrected to the proper GSDF gradation, can be displayed.

Thus, since the modification on a basis of the application is not required, even by an application newly installed in the image viewer web server 14, the user terminal 16a can activate the medical image display program 38 to instantly display the medical image data after conversion 13b, which is corrected to the proper GSDF gradation.

Moreover, since the medical image display program 38 allows the input manipulation to the touch input part 21a to be transmitted, maneuverability of the application such as the image viewer web application 14a provided in the image viewer web server 14 can be maintained.

Moreover, the user terminal 16a that activates the medical image display program 38 performs a series of processing from the transmission of the input manipulation in the touch input part 21a (step S1) to the image display after the image conversion (step S5) in each frame. This enables the user to manipulate the user terminal 16a with stress-free comfortable response and check the medical image data after conversion 13b. Moreover, the use of the image processing library 35a enables the user terminal 16a to realize the high-speed processing.

Moreover, the user terminal 16a allows the user to use the medical image display device that the user usually uses as it is, and performs the GSDF display with display quality managed without impairing convenience.

Moreover, since as to the user terminal 16a, the display quality management can be performed without adding a new function to the system, management costs of the image display quality can be greatly reduced.

While in the above-described embodiment, the whole display screen displayed by the image viewer web application 14a is an object of the GSDF conversion, a configuration may be employed in which only the medical image displayed by the image viewer web application 14a is subjected to the GSDF conversion. In this case, the image conversion part 35 may subject, to the GSDF conversion, only the image data of the data that the browser function part 32 acquired from the image viewer web server 14. This enables the user terminal 16a to display only a medical image portion in the gradation after the GSDF conversion without changing colors of portions other than the medical image (other portions) such as a menu portion.

In this manner, the user terminal 16a holds the LUT data 39 as the display gradation characteristic information on the user terminal 16a side, and can perform, in accordance with the display gradation characteristic information, the gradation correction for the image sent from the image server 12 having no gradation correction function, or an interface in which the image is displayed, or the whole screen on which the foregoing is displayed without the gradation being corrected.

Moreover, the user terminal 16a may have a configuration in which the image acquired from the image viewer web server 14 by a bookmarklet or the like using JAVA (registered trademark) Script is converted by the image conversion part 35.

### Second Embodiment

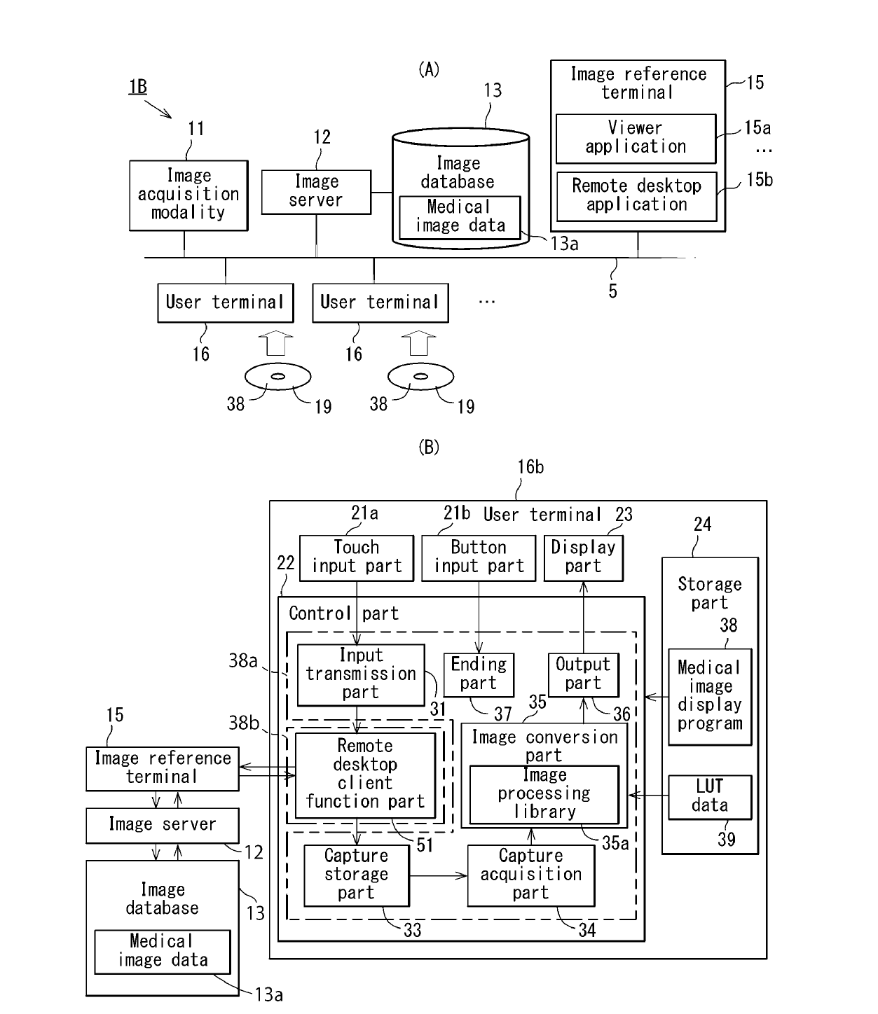

FIG. 3(A) is a block diagram illustrating a system configuration of a medical image display system 1B of a second embodiment. The medical image display system 1B has an image acquisition modality 11, an image server 12, a plurality of image reference terminals 15 (external computers), and a plurality of user terminals 16 (computers), which are connected to an electric communication line 5.

The image reference terminals 15 each have a storage part that stores a program and data, an input part such as a mouse, a keyboard, or a touch panel that accepts manipulation input, a display part that performs display, a communication part that communicates through the electric communication line 5, and a control part that controls these components. As to the image reference terminal 15, a viewer application 15a and a remote desktop application 15b (an external application) are installed in the storage part. The remote desktop application 15b receives data for manipulation to find medical image data 13a from a client (the user terminal 16) who is remotely logged-in, and performs operation of the viewer application 15a in accordance with this data for manipulation. The remote desktop application 15b sends output including the medical image data 13a from the viewer application 15a to the client as output data. The user terminals 16 correspond to the image reference terminals 15 in one-to-one relation. Thus, the same number of image reference terminals 15 as that of the user terminals 16 that refer to the image are desirably provided.

Since the image acquisition modality 11, the image server 12, and the user terminal 16 are the same as those in the first embodiment, the same reference numerals will be given to the same components, and detailed description thereof will be omitted.

FIG. 3(B) is a block diagram illustrating a hardware configuration and functional blocks of a user terminal 16b when the image reference terminal 15 is remotely controlled to manipulate the viewer application 15a, by which the medical image is displayed, as one example of the user terminal 16.

The user terminal 16b includes a touch input part 21a, a button input part 21b, a control part 22, a display part 23, and a storage part 24 by a flash memory. The control part 22 executes a medical image display program 38 stored in the storage part 24 as an application, and functions as an input/output processing part 38a and a viewer part 38b.

The viewer part 38b has a remote desktop client function part 51 that functions as a remote desktop client for remotely using a viewer application for desktop. The viewer part 38b receives the manipulation input through the input/output processing part 38a and accesses the image reference terminal 15 to remotely control the image reference terminal 15. The remotely-controlled image reference terminal 15 accesses the image server 12 to acquire the medical image data 13a of an image database 13, and sends the medical image data 13a to the viewer part 38b (the remote desktop client function part 51). The viewer part 38b performs capture output of the acquired medical image data 13a to a capture storage part 33.

The remote desktop client function part 51 accepts an input signal by image reference manipulation received from the input transmission part 31 in an input signal acceptance part, which is not illustrated, and accesses the image reference terminal 15 in accordance with this input signal to remotely control the image reference terminal 15. That is, when the remote desktop client function part 51 sends the input signal received through the input transmission part 31 to the image reference terminal 15, the image reference terminal 15 performs operation corresponding to the received input signal to display the medical image data 13a on a screen of the image reference terminal 15, and send screen data after the operation to the remote desktop client function part 51. The remote desktop client function part 51 creates image data for display such as RGB image data for performing screen display on the display part 23 from the image data including the received medical image data 13a, and performs capture output of the image data for display to the capture storage part 33 by an output part for display, which is not illustrated.

Accordingly, the remote desktop client function part 51 displays, in the display part 23 of the user terminal 16b, the same screen as the screen displayed in the display part of the image reference terminal 15, and transfers the input signal inputted to the screen in the touch input part 21a to the image reference terminal 15, to operate the image reference terminal 15 for the screen display as if the user directly operated the image reference terminal 15.

Since configurations and operation other than those of the viewer part 38b are the same as those of the first embodiment, the same reference numerals will be given to the same components, and detailed description thereof will be omitted.

The user terminal 16b configured as described above performs the same operation as the operation described in the first embodiment with reference to FIG. 2(A) except that the content of step 2 is different.

In step S2, when the user terminal 16b transmits the input data by the input transmission part 31 and transfers the input data to the viewer part 38b, the viewer part 38b performs operation (step S2). The remote desktop client function part 51 that operates as the viewer part 38b remotely logs in to the image reference terminal 15 to remotely control the image reference terminal 15. Thereafter, all information displayed on a desktop of the image reference terminal 15 is subjected to image conversion by an image conversion part 35 and is then displayed almost as it is in the display part 23 of the user terminal 16b. The remotely-controlled image reference terminal 15 receives data of the screen including the medical image data 13a of the image database 13 through the image server 12 and creates the image data for display from this data of the screen. The remote desktop client function part 51 draws the image data for display acquired from the image reference terminal 15 so as to capture the same in the capture storage part 33 (the memory). Since the other operation is the same as that of the first embodiment, detailed description thereof will be omitted.

By the above-described configuration and operation, in the medical image display system 1B, the viewer application 15a for browsing the medical image data 13a is executed on the image reference terminal 15, which is a different terminal from the user terminal 16b used by the user such as a virtual desk top. The user terminal 16b is connected to this image reference terminal 15 through the remote desktop client function part 51, so that the remote desktop, or only the image can be corrected to the GSDF gradation to be displayed. Accordingly, the user can manipulate the user terminal 16b to browse the medical image data 13a with the image quality and in the gradation proper for diagnosis. In this manner, the medical image display system 1B can bring about the same effects as those in the first embodiment.

Moreover, since the application that can be activated in the image reference terminal 15 need not be a web-based application, various applications can be used.

While in the second embodiment, the whole display screen displayed by the remote desktop client function part 51 is an object of the GSDF conversion, a configuration may be employed in which only the medical image displayed in the remote desktop client function part 51 is subjected to the GSDF conversion. In this case, only the image data of the data that the remote desktop client function part 51 acquires from the image reference terminal 15 may be subjected to the GSDF conversion in the image conversion part 35. This allows only the medical image portion to be displayed in gradation after the GSDF conversion without changing colors of portions other than the medical image such as a menu portion.

Moreover, the user terminals 16a, 16b of the first and second embodiments each have a mechanism of performing filtering for LUT conversion and uniformity correction for the GSDF display in a platform of the web browser, the remote desktop client, or the like. This enables drawing with managed display quality to be utilized in the formerly-used medical image display device.

### Third Embodiment

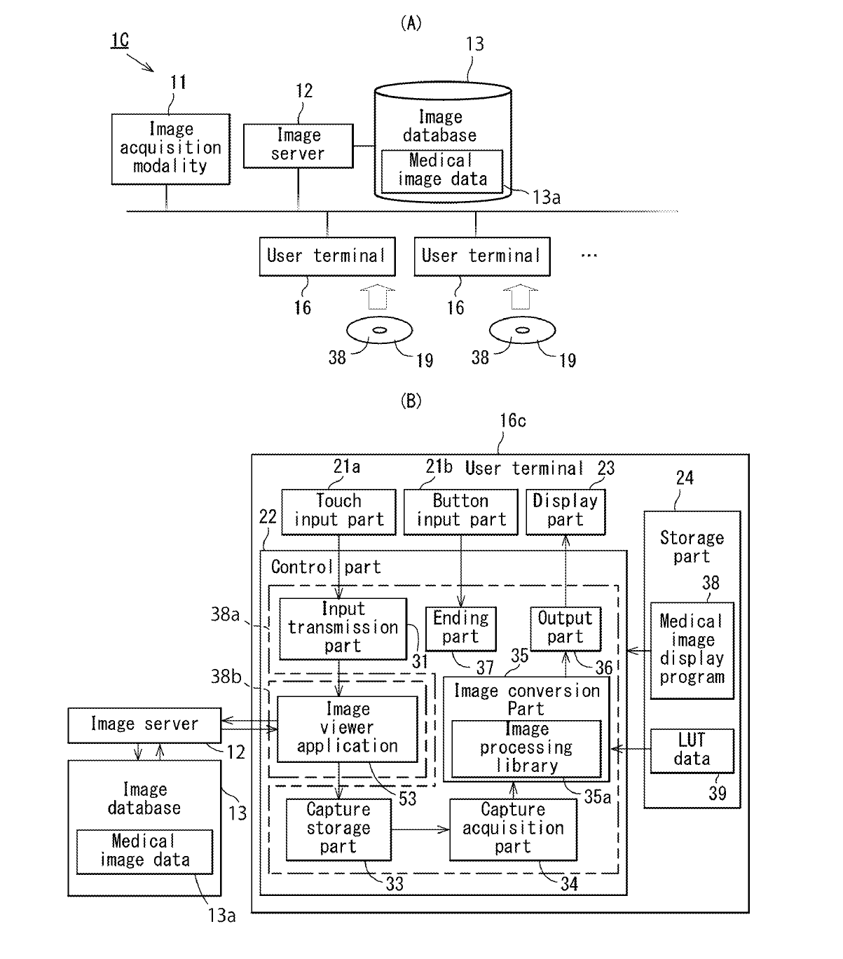

FIG. 4(A) is a block diagram illustrating a system configuration of a medical image display system 1C of a third embodiment. The medical image display system 1C has an image acquisition modality 11, an image server 12, and a plurality of user terminals 16, which are connected to an electric communication line 5.

Since the image acquisition modality 11, the image server 12, and the user terminal 16 are the same as those of the first embodiment, the same reference numerals will be given to the same components, and detailed description thereof will be omitted.

FIG. 4(B) is a block diagram illustrating a hardware configuration and functional blocks of a user terminal 16c when a medical image is displayed by an image viewer application 53, as one example of the user terminal 16.

The user terminal 16c includes a touch input part 21a, a button input part 21b, a control part 22, a display part 23, and a storage part 24 by a flash memory. The control part 22 executes a medical image display program 38 stored in the storage part 24 as an application, and functions as an input/output processing part 38a and a viewer part 38b.

The viewer part 38b has the image viewer application 53. The image viewer application 53 receives manipulation input through the input/output processing part 38a, and accesses the image server 12 to acquire medical image data and perform capture output to a capture storage part 33.

The image viewer application 53 accesses the image server 12 in accordance with an input signal by image reference manipulation received from an input transmission part 31 to receive the medical image data 13a managed in an image database 13. The image viewer application 53 creates image data for display such as RGB image data including data of a text and a button to be displayed in the image viewer application 53 as well as the received medical image data 13a, and performs capture output of this image data for display 13a to a capture storage part 33.

Since configurations and operation other than those of the viewer part 38b are the same as those of the first embodiment, the same reference numerals will be given to the same components and detailed description thereof will be omitted.

The user terminal 16c configured as described above performs the same operation as the operation described in the first embodiment with reference to FIG. 2(A) except that the content of step 2 is different.

In step S2, when the user terminal 16c transmits the input data by the input transmission part 31 and transfers the input data to the viewer part 38b, the viewer part 38b performs operation (step S2). The image viewer application 53 operating as the viewer part 38b acquires the required medical image data 13a from the image server 12. The image viewer application 53 creates the image data for display in which the medical image data 13a is displayed together with a menu screen and the like provided by itself, and draws the image data for display so as to capture the image in the capture storage part 33 (the memory). Since other operation is the same as that of the first embodiment, detailed description thereof will be omitted.

Although by the above-described configuration and operation, the user terminal 16c cannot use various applications that operate in the image viewer web server 14 (refer to the first embodiment) or the image reference terminal 15 (refer to the second embodiment), the image viewer application 53 can bring about similar effects to those of the first embodiment as an application loaded on the user terminal 16c.

### Fourth Embodiment

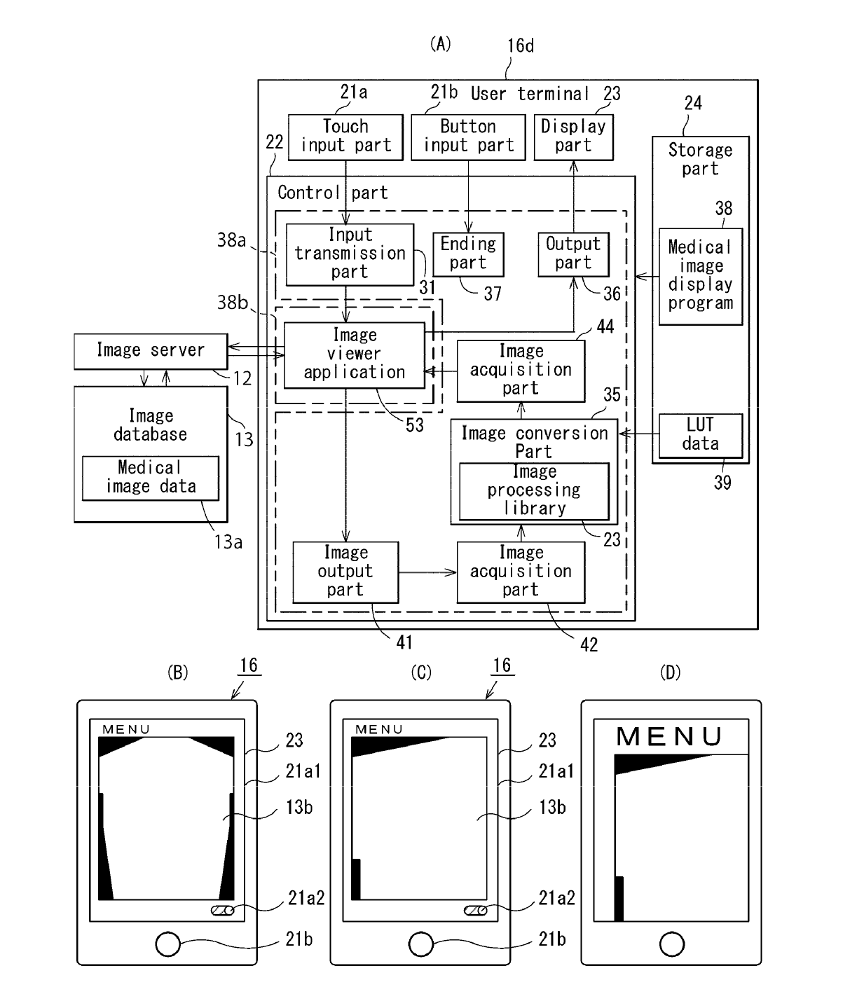

FIG. 5(A) is a block diagram illustrating a hardware configuration and functional blocks of a user terminal 16d when a medical image is displayed by an image viewer application 53, as one example of a user terminal 16.

The user terminal 16d includes an image output part 41, an image acquisition part 42, and an image acquisition part 44 in place of the capture storage part 33 and the capture acquisition part 34 in the third embodiment.

The image output part 41 outputs medical image data 13a received from an image server 12 by the image viewer application 53 to an input/output processing part 38a. The image acquisition part 42 in the input/output processing part 38a acquires the medical image data 13a to pass the same to an image conversion part 35, and the image conversion part 35 performs the GSDF conversion.

The image acquisition part 44 acquires medical image data after conversion 13b subjected to the GSDF conversion to send the same to the image viewer application 53.

The image viewer application 53 outputs the medical image data after conversion 13b through an output part 36 to a display part 23.

Since other configurations and operation are the same as those of the third embodiment, the same reference numerals will be given to the same components, and detailed description thereof will be omitted.

The above-described configurations and operation can bring about similar effects to those of the third embodiment.

In the above-described embodiments, the button input part 21b may not be a button but a partial region of the touch panel. In this case, an inputtable region of the touch panel is divided into a region of a first input part and a region of a second input part, and subsequent operation may be sorted, depending on in which of the regions input is performed.

Moreover, as shown in an exterior appearance diagram of FIG. 5(B), the touch input part 21a may be divided into a region of a touch input part for transmission 21a1 and a region of a touch input part for control 21a2 in the display part 23. In this case, the touch input part for transmission 21a1 may be an interface to input a manipulation instruction to the viewer part 38b (first input data) similar to the touch input part 21a of the above-described embodiments, and the touch input part for control 21a2 may be an interface to input a manipulation instruction to the input/output processing part 38a (second input data). In the illustrated example, the user terminal 16 (16a, 16b, 16c) switches the presence and absence of the image conversion by the image conversion part 35 by manipulation to switch ON/OFF of the touch input part for control 21a2. While processing is the same as the above-described embodiments in the case where the image conversion is present, if switching to the absence of the image conversion is performed, a configuration is such that the user terminal 16 delivers the data outputted from the capture acquisition part 34 to the output part 36 as it is without passing the data through the image conversion part 35. This allows the user terminal 16 to transmit the input manipulation of the touch input part for transmission 21a1, which is a portion other than the touch input part for control 21a2, and input the input manipulation to the viewer part 38b while switching the presence/absence of the image conversion by the image conversion part 35 by the touch input part for control 21a2. Accordingly, the user terminal 16 can perform enlargement manipulation or the like of the medical image data after conversion 13b displayed in the display part 23 (the medical image data 13a if the image conversion is not performed), as shown in an exterior appearance diagram of FIG. 4(C).

In this manner, since in the user terminal 16, the input manipulation region to the input/output processing part 38a (the button input part 21b and the touch input part for control 21a2), and the input manipulation region to the viewer part 38b (the touch input part 21a or the touch input part for transmission 21a1) are divided, for example, a situation can be prevented, in which all of the display including the menu displayed by the viewer part 38b are enlarged as shown in a reference diagram of FIG. 5(D) when the enlargement manipulation is performed, so that the proper input manipulation to the viewer part 38b is enabled.

### INDUSTRIAL APPLICABILITY

The present invention can be utilized not only for a system that displays a medical image, but for various purposes in which the image is desirably calibrated and displayed in a user terminal.

### DESCRIPTION OF REFERENCE SIGNS

1A, 1B, 1C: Medical image display system

5: Electric communication line

13a: Medical image data

16, 16a, 16b, 16c, 16d: User terminal

21a: Touch input part

21a1: Touch input part for transmission

21a2: Touch input part for control

21b: Button input part

23: Display part

31: Input transmission part

32: Browser function part

33: Capture storage part

34: Capture acquisition part

35: Image conversion part

36: Output part

38: Medical image display program

38b: Viewer part

51: Remote desktop client function part

52: Image viewer application

1. A medical image display program that causes a computer to function as:
a communication application part that accesses, through an electric communication line, an external computer that acquires medical image data to acquire at least the medical image data;
an input acceptance part that accepts manipulation input by a user;
an input data transfer part that transfers input data accepted in the input acceptance part to the communication application part;
a display image data acquisition part that acquires image data for display including the medical image data outputted from the communication application part;
an image conversion part that performs image conversion of at least a medical image data portion of the image data for display; and
an output part that outputs the image data for display after conversion to a display part.

2. The medical image display program according to claim 1, wherein
the communication application part performs capture output of the image data for display to a temporary storage part, and
the display image data acquisition part acquires the image data for display from the temporary storage part.

3. The medical image display program according to claim 1, wherein
the input data transfer part performs different processing, depending on whether the input data inputted in the input part is first input data or second input data,
when the input data is the first input data, the first input data is transmitted and transferred to the communication application part without performing operation corresponding to the first input data, and
when the input data is the second input data, operation corresponding to the second input data is performed.

4. The medical image display program according to claim 1, wherein
the communication application part
sends, to an external application that operates in the external computer, data for manipulation to manipulate the external application, and
receives output data from the external application, the output data being a result from the external application operating corresponding to the data for manipulation.

5. The medical image display program according to claim 1, wherein the image conversion part converts only the medical image data of the image for display, and does not convert other portions.

6. A medical image display method comprising:
accessing, through an electric communication line, an external computer that acquires medical image data to acquire at least the medical image data by a communication application part;
accepting, by an input acceptance part, manipulation input by a user;
transferring, by an input data transfer part, input data accepted in the input acceptance part to the communication application part;
acquiring, by a display image data acquisition part, image data for display including the medical image data outputted from the communication application part;
performing, by an image conversion part, image conversion of at least a medical image data portion of the image data for display; and
outputting, by an output part, the image data for display after conversion to a display part.

7. A medical image display device comprising:
a communication application part that accesses, through an electric communication line, an external computer that acquires medical image data to acquire at least the medical image data;
an input acceptance part that accepts manipulation input by a user;
an input data transfer part that transfers input data accepted in the input acceptance part to the communication application part;
a display image data acquisition part that acquires image data for display including the medical image data outputted from the communication application part;
an image conversion part that performs image conversion of at least a medical image data portion of the image data for display; and
an output part that outputs the image data for display after conversion to a display part.

8. A medical image display system comprising:
an external computer that acquires medical image data; and
a user terminal that accesses an image server through an electric communication line,
the user terminal comprising:
a communication application part that accesses the external computer through the electric communication line to acquire at least the medical image data;
an input acceptance part that accepts manipulation input by a user;
an input data transfer part that transfers input data accepted in the input acceptance part to the communication application part;
a display image data acquisition part that acquires image data for display including the medical image data outputted from the communication application part;
an image conversion part that performs image conversion of at least a medical image data portion of the image data for display; and
an output part that outputs the image data for display after conversion to a display part.
